(19) United States
(12) Patent Application Publication
(10) Pub. No.: US 2023/0373710 A1
(43) Pub. Date: Nov. 23, 2023

(54) VERTICALLY-ASSEMBLED GARBAGE CAN

(71) Applicant: Jiangmen Jinlong High Technology Industrial Co., Ltd., Guangdong (CN)

(72) Inventor: Jinsheng LIAO, Guangdong (CN)

(21) Appl. No.: 17/851,219

(22) Filed: Jun. 28, 2022

(30) Foreign Application Priority Data
May 18, 2022 (CN) 202221198153.8

(51) Int. Cl. B65F 1/02

(52) U.S. Cl. CPC B65F 1/02; B65F 2220/12

(57) ABSTRACT

A vertically-assembled garbage can is disclosed, including a middle frame and two can bodies. The two can bodies are respectively mounted on both sides of the middle frame along a vertical direction. An outer diameter of one of the can bodies is smaller than or equal to an inner diameter of the other one of the can bodies, the two can bodies are both provided with an abutting edge, at least one of the can bodies is detachably connected with the middle frame through a fastening structure, and the abutting edge is matched with the fastening structure to fix the can body.

### CROSS-REFERENCE TO RELATED APPLICATION

This application is based on and claims the benefit of priority from Chinese Patent Application No. 2022211981538, filed on 18 May 2022, the entirety of which is incorporated by reference herein.

### TECHNICAL FIELD

The disclosure relates to the technical field of garbage cans, and more particularly, to a vertically-assembled garbage can.

### BACKGROUND

Existing garbage cans are typically used in cooperation with a plastic bag. The plastic bag is put into the garbage can when in use. When there are too many garbages, the plastic bag may be tied up and thrown away directly, thus being convenient to use. In addition, in order to prevent odor from spreading, the garbage cans are provided with a cover. However, most of the existing garbage cans have an integral structure. For manufacturers, the garbage can occupies a large space, has a large packaging structure, is inconvenient to transport, and has a high transportation costs. Some garbage cans have an assembled structure, which however are often unstable and unsuitable for use after assembly, or have a complicated assembled structure, thus being inconvenient for a user to assemble.

### SUMMARY

The disclosure aims to solve at least one of the technical problems in the existing technology. Therefore, the disclosure provides a vertically-assembled garbage can, which can be transported separately, occupies a small space, has a relatively small packaging structure, is convenient to transport, and effectively reduces a transportation cost. Meanwhile, the garbage can has a simple assembly mode, which is convenient for a user to assemble, and a firm structure, which is convenient to use.

A vertically-assembled garbage can according to an embodiment of the disclosure includes: a middle frame; and respectively mounted on both sides of the middle frame along a vertical direction, where an outer diameter of one of the can bodies is smaller than or equal to an inner diameter of the other one of the can bodies, the two can bodies are both provided with an abutting edge, at least one of the can bodies is detachably connected with the middle frame through a fastening structure, and the abutting edge is matched with the fastening structure to fix the can body.

The above technical solution has at least the following beneficial effects: at least one of the two can bodies is detachably connected with the middle frame, and the outer diameter of one can body is smaller than or equal to the inner diameter of the other can body, so that the garbage can may be configured as a separated type during transportation, and the can body with the small outer diameter is accommodated in the can body with the large inner diameter, which can reduce an occupied space, thus reducing a packaging structure, being convenient for transportation and effectively reducing a transportation cost. Meanwhile, since the can bodies and the middle frame are assembled by matching the abutting edges with the fastening structure, a whole structure is simple, and an assembly mode is simple, thus being convenient for a user to assemble, and the can bodies can be tightly fastened to the middle frame to realize firm and reliable connection, thus being convenient to use.

According to some embodiments of the disclosure, the fastening structure includes a fastening hole arranged in the middle frame and a fastening nail connected to the can body, the abutting edge is arranged to abut against the middle frame, the fastening nail is arranged penetrating through the fastening hole and is fastened to the middle frame, and a direction of a force of the abutting edge acting on the middle frame is opposite to a direction of a force of the fastening nail acting on the middle frame.

According to some embodiments of the disclosure, an inner wall of the can body is provided with a concave position, and an end portion of the fastening nail is accommodated in the concave position.

According to some embodiments of the disclosure, the can body mounted on a lower side of the middle frame is a second can body; in case that the second can body is detachably connected with the middle frame through the fastening structure, the middle frame is provided with a protruding portion protruding towards an interior of the garbage can, and the abutting edge of the second can body is arranged to abut against a lower side of the protruding portion.

According to some embodiments of the disclosure, an end surface of the protruding portion facing the interior of the garbage can is flush with an inner wall of the second can body.

According to some embodiments of the disclosure, the fastening structure includes a mounting groove and a clamping block which are arranged in the middle frame, the clamping block is arranged on a side wall of the mounting groove, and the abutting edge is accommodated in the mounting groove and fastened to the clamping block.

According to some embodiments of the disclosure, the clamping block is provided with a guide portion facing an opening of the mounting groove.

According to some embodiments of the disclosure, the can body mounted on a lower side of the middle frame is a second can body; in case that the second can body is detachably connected with the middle frame through the fastening structure, the second can body is provided with an externally expanded step position, a part of the middle frame is accommodated in the step position, and an inner wall of the middle frame is flush with an inner wall of the second can body.

According to some embodiments of the disclosure, the two can bodies are respectively provided as a first can body mounted on an upper side of the middle frame and a second can body mounted on a lower side of the middle frame, and an outer diameter of the second can body is smaller than or equal to an inner diameter of the first can body.

According to some embodiments of the disclosure, the abutting edge is provided as a curled structure.

The additional aspects and advantages of the disclosure will be partially provided in the following description, and will partially be apparent in the following description, or learned by practice of the disclosure.

### BRIEF DESCRIPTION OF THE DRAWINGS

The above and/or additional aspects and advantages of the disclosure will be apparent and easily understood from the descriptions of the embodiments with reference to the following drawings, wherein:

FIG. 1 is a schematic structural diagram of a garbage can in an embodiment of the disclosure;

FIG. 2 is an exploded view of the garbage can in an embodiment of the disclosure;

FIG. 3 is a front cross-sectional view of the garbage can in an embodiment of the disclosure;

FIG. 4 is an enlarged view of part A in FIG. 3; and

FIG. 5 is a partial cross-sectional view of a connecting structure between a second can body and a middle frame in another embodiment of the disclosure.

### REFERENCE NUMERALS

100 refers to first can body; 110 refers to first abutting edge;
200 refers to second can body; 210 refers to second abutting edge; 220 refers to fastening nail; 230 refers to concave position; 240 refers to step position;
300 refers to middle frame; 310 refers to inner plate; 320 refers to outer plate; 330 refers to connecting plate; 340 refers to fastening hole; 350 refers to protruding portion; 360 refers to mounting groove; 370 refers to clamping block; 371 refers to guide portion;
400 refers to bottom base;
500 refers to cover base; and
600 refers to cover.

### DETAILED DESCRIPTION

This part will describe the specific embodiments of the disclosure in detail, and the preferred embodiments of the disclosure are shown in the drawings. The drawings are used to supplement the description of the text in the specification with the graphs, so that people can intuitively and vividly understand each technical feature and the overall technical solution of the disclosure, but the drawings cannot be understood as limiting the scope of protection of the disclosure.

In the description of the disclosure, it should be understood that the orientations or positional relationships indicated by the terms such as “upper”, “lower”, “front”, “rear”, “left”, “right” and the like, refer to the orientations or positional relationships shown in the drawings, which are only intended to facilitate describing the disclosure and simplifying the description, and do not indicate or imply that the indicated devices or elements must have a specific orientation, be constructed and operated in a specific orientation, and therefore cannot be understood as a limitation of the disclosure.

In the description of the disclosure, “several” refers to being one or more, “a plurality of” refers to being two or more, and “greater than”, “less than”, “more than”, and the like are understood as not including this number, while “above”, “below”, “within”, and the like are understood as including this number. If there are the descriptions of first and second, it is only for the purpose of distinguishing between technical features, and should not be understood as indicating or implying relative importance, implicitly indicating the number of the indicated technical features or implicitly indicating the order of the indicated technical features.

In the description of the disclosure, the terms “arrangement”, “installation”, “connection”, and the like should be understood in broad sense unless otherwise specified and defined. The specific meaning of the above terms in the disclosure may be reasonably determined according to specific contents of the technical solutions by those of ordinary skills in the art.

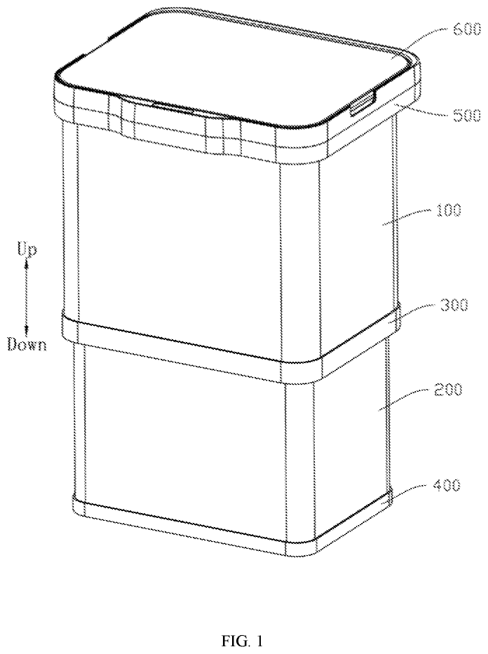

With reference to FIG. 1 to FIG. 5, an embodiment of the disclosure provides an up-down assembled garbage can, the garbage can may be an induction garbage can or a mechanical flip garbage can, and the garbage can includes a middle frame 300 and two can bodies.

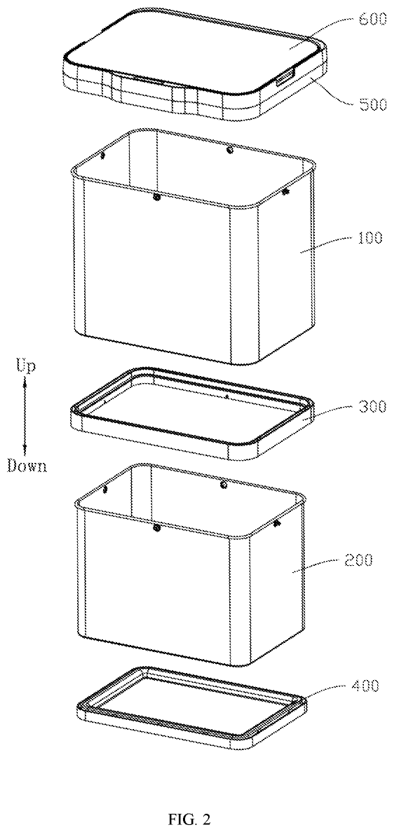

With reference to FIG. 1 to FIG. 2, it can be understood that the middle frame 300 is provided as an annular structure, the two can bodies are both provided as an annular structure, and the can bodies are penetrated through along a vertical direction. Moreover, an upper end and a lower end of each of the can bodies are both provided with an abutting edge. Typically, the middle frame 300 is a plastic member, and the can bodies are sheet metal members.

With reference to FIG. 1 to FIG. 4, it can be understood that the two can bodies are respectively provided as a first can body 100 and a second can body 200. The first can body 100 is mounted on an upper side of the middle frame 300, and the second can body 200 is mounted on a lower side of the middle frame 300. An upper end and a lower end of the first can body 100 are respectively provided with a first abutting edge 110, and an upper end and a lower end of the second can body 200 are respectively provided with a second abutting edge 210. The first abutting edge 110 and the second abutting edge 210 are both provided as a curled structure, which is convenient for processing on one hand, and can increase a structural strength of the can bodies on the other hand, and can avoid burrs and sharp edges at the upper ends and the lower ends of the can bodies from scratching a user, thus improving safety.

With reference to FIG. 1 and FIG. 2, it can be understood that at least one can body is detachably connected with the middle frame 300 through a fastening structure, and mounted by matching the abutting edge with the fastening structure. Specifically, the first can body 100 and the second can body 200 are both detachably connected with the middle frame 300, the first can body 100 is mounted on the upper side of the middle frame 300 by matching the first abutting edge 110 with the fastening structure, and the second can body 200 is mounted on the lower side of the middle frame 300 by matching the second abutting edge 210 with the fastening structure. In this way, the first can body 100, the second can body 200 and the middle frame 300 are capable of being separated from one another, so that the first can body 100 and the second can body 200 can be nested with each other, thus reducing an occupied space and a packaging structure, and effectively reducing a transportation cost. The middle frame 300 may be placed in the first can body 100 or the second can body 200 during delivery, or the middle frame 300 may be mounted in one of the first can body 100 and the second can body 200 in advance.

In an embodiment, the middle frame 300 may also be directly fixed to the upper end of the second can body 200, and the first can body 100 is detachably connected with the middle frame 300; or the middle frame 300 is directly fixed to the lower end of the first can body 100, and the second can body 200 is detachably connected with the middle frame 300. In this way, the first can body 100 and the second can body 200 of the garbage can are also capable of being separated from each other, so that the first can body 100 and the second can body 200 can be nested with each other, thus reducing an occupied space and a packaging structure, and effectively reducing a transportation cost.

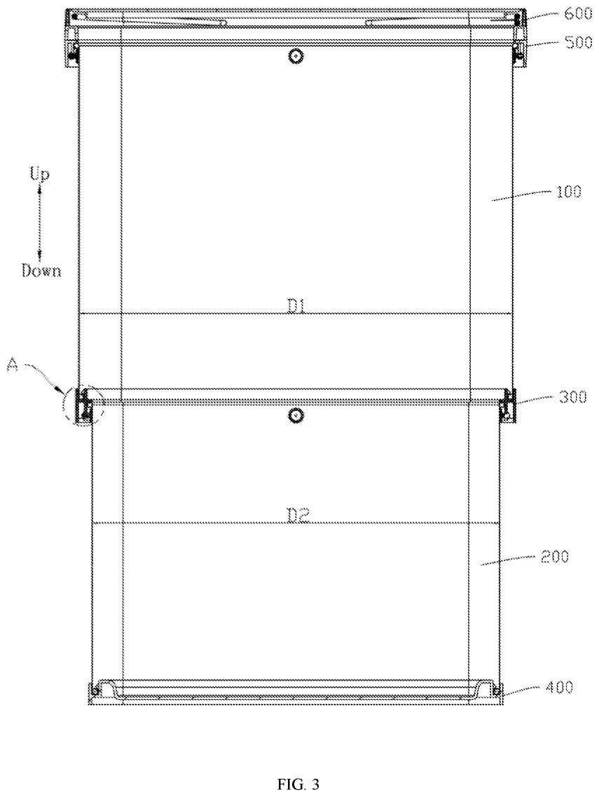

With reference to FIG. 3, it can be understood that when the outer diameter of one can body is compared with the inner diameter of the other can body, the outer diameter and the inner diameter in the same radial direction are used for comparison. The outer diameter of one can body is smaller than or equal to the inner diameter of the other can body, which means that in any radial direction, the outer diameter of one can body in the radial direction is smaller than or equal to the inner diameter of the other can body in the radial direction. Specifically, an outer diameter D2 of the second can body 200 is smaller than or equal to an inner diameter D1 of the first can body 100. On one hand, the second can body 200 can be accommodated in the first can body 100, thus reducing an occupied space and being convenient for transportation. On the other hand, when the first can body 100, the second can body 200 and the middle frame 300 are assembled into the garbage can, an externally expanded stepped structure can be formed at an upper portion of an inner wall of the garbage can. When it is necessary to take out a plastic bag placed in the garbage can, a defect that the plastic bag is damaged or cannot be taken out due to that the inner wall of the garbage can clamps the plastic bag can be avoided, and the plastic bag can be taken out conveniently.

With reference to FIG. 1 to FIG. 3, it can be understood that the lower end of the second can body 200 is also provided with a bottom base 400, and the second can body 200 may be detachably connected with the bottom base 400. The upper end of the first can body 100 is provided with a cover base 500, and the first can body 100 may be detachably connected with the cover base 500. A cover 600 is rotatably arranged on the cover base 500 for opening or closing the garbage can, and the cover base 500 is provided with a touch-sensitive switch structure for controlling opening or closing of the cover 600, thus being convenient for the user to use and being sanitary.

By detachably connecting the first can body 100 with the middle frame 300 and detachably connecting the second can body 200 with the middle frame 300, and allowing the outer diameter of the second can body 200 to be smaller than or equal to the inner diameter of the first can body 100, the garbage can may be separated during packaging and transportation, which means that the first can body 100 and the second can body 200 are separated, and the second can body 200 is accommodated in the first can body 100, thus reducing an occupied space, reducing a packaging structure, being convenient for transportation, and effectively reducing a transportation cost. Meanwhile, since the first can body 100 and the middle frame 300, and the second can body 200 and the middle frame 300 are both assembled by matching the abutting edges with the fastening structure, the user may mount the middle frame 300 at the upper end of the second can body 200 first, and then mount the lower end of the first can body 100 to the middle frame 300 during assembly to form the garbage can of a stepped structure with an inner diameter reduced from top to bottom, thus being convenient to take out the plastic bag of the garbage can. The garbage can has a simple overall structure and a simple assembly mode, thus being convenient for the user to assemble. The first can body 100 and the second can body 200 may both be tightly fastened to the middle frame 300 to realize firm and reliable connection, thus being convenient to use.

Noted that, the number of the can bodies are not limited to two, and the number of the middle frame 300 is not limited to one. According to a height of the garbage can, three, four or more can bodies may be provided, inner diameters of a plurality of can bodies are increased from bottom to top, and two adjacent can bodies are abutted by one middle frame 300, which will not be repeated herein.

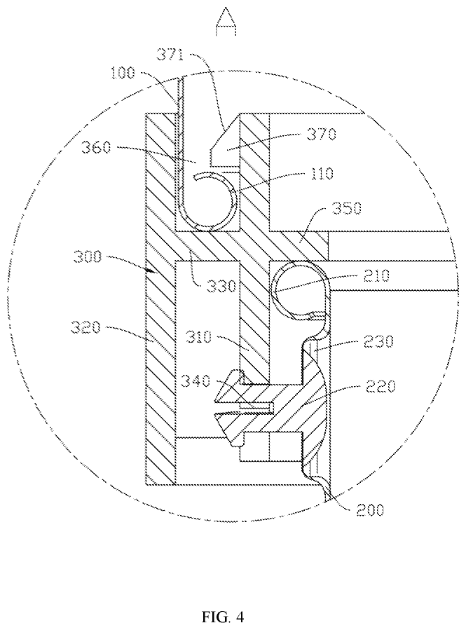

With reference to FIG. 3 to FIG. 4, it can be understood that an interior of the garbage can is defined as an inside direction, and a corresponding exterior is defined as an outside direction. The middle frame 300 includes an inner plate 310 located inside, an outer plate 320 located outside, and a connecting plate 330 connecting the inner plate 310 with the outer plate 320, and the inner plate 310 is parallel to the outer plate 320.

The first can body 100 being detachably connected with the middle frame 300, and the second can body 200 being detachably connected with the middle frame 300 is taken as an example for detailed description hereinafter.

With reference to FIG. 3 and FIG. 4, it can be understood that the fastening structure between the second can body 200 and the middle frame 300 includes a fastening hole 340 arranged in the middle frame 300 and a fastening nail 220 connected to the second can body 200. The second abutting edge 210 at the upper end of the second can body 200 abuts against an inner wall of the inner plate 310, thus having a supporting effect. Specifically, the fastening hole 340 is arranged in the inner plate 310, and the fastening nail 220 is provided as a press button. Typically, the second can body 200 is provided with a through hole, and the fastening nail 220 is arranged penetrating through the through hole and the fastening hole 340 along a radial direction of the garbage can, and one end of the fastening nail 220 is fastened to an inner wall of the second can body 200, and the other end of the fastening nail is fastened to an outer wall of the inner plate 310. In this way, a direction of a force of the second abutting edge 210 acting on the inner plate 310 is opposite to a direction of a force of the fastening nail 220 acting on the inner plate 310. Under a supporting effect of the second abutting edge 210 and a pulling force of the fastening nail 220, the second can body 200 and the middle frame 300 can be tightened to each other, so that the middle frame 300 is stably and reliably mounted on the second can body 200, thus being not easy to fall off, and being convenient to use. The second abutting edge 210 at the upper end of the second can body 200 abuts against the inner wall of the inner plate 310 during assembly, and the fastening nail 220 is pressed to penetrate through the through hole in the second can body 200 and the fastening hole 340 in the middle frame 300 in sequence to complete the assembly, which is simple in operation, thus being convenient for the user to operate.

With reference to FIG. 3 and FIG. 4, it can be understood that the inner wall of the second can body 200 is provided with a concave position 230, the concave position 230 is arranged at the through hole, and an end portion of the fastening nail 220 is accommodated in the concave position 230, so that the end portion of the fastening nail 220 is avoided from protruding from the inner wall of the second can body 200, and a defect that the plastic bag cannot be taken out due to that the fastening nail 220 clamps the plastic bag is avoided, thus being convenient for the user to take out the plastic bag in the garbage can.

With reference to FIG. 3 and FIG. 4, it can be understood that the inner plate 310 of the middle frame 300 is provided with a protruding portion 350, and the protruding portion 350 protrudes towards the interior of the garbage can. Specifically, the protruding portion 350 is provided as a convex ring, the convex ring is arranged along a circumferential direction of the middle frame 300, and a lower side of the protruding portion 350 abuts against the second abutting edge 210 at the upper end of the second can body 200, so that the middle frame 300 may be positioned to allow the through hole of the second can body 200 to be aligned with the fastening hole 340, thus being convenient for the user to penetrate the fastening nail 220 through the through hole and the fastening hole 340, and being convenient to assemble the middle frame 300 and the second can body 200.

In an embodiment, the protruding portion 350 may include a plurality of bumps, and the plurality of bumps are arranged at intervals along the circumferential direction of the middle frame 300, which will not be repeated herein.

With reference to FIG. 3 and FIG. 4, it can be understood that an end surface of the protruding portion 350 facing the interior of the garbage can is flush with the inner wall of the second can body 200, so that the protruding portion 350 can be avoided from protruding from the inner wall of the second can body 200, and a defect that the plastic bag is damaged or cannot be taken out due to that the protruding portion 350 clamps the plastic bag is avoided, thus being convenient for the user to take out the plastic bag in the garbage can.

With reference to FIG. 3 and FIG. 4, it can be understood that the fastening structure between the first can body 100 and the middle frame 300 includes a mounting groove 360 and a clamping block 370 which are arranged in the middle frame 300. Specifically, the mounting groove 360 with an upward opening is formed by the outer plate 320, the inner plate 310 and the connecting plate 330, the clamping block 370 is arranged on the inner plate 310 and located in the mounting groove 360, and the first abutting edge 110 at the lower end of the first can body 100 is accommodated in the mounting groove 360 and fastened to the clamping block 370. When the first can body 100 is mounted in the middle frame 300, the first abutting edge 110 at the lower end of the first can body 100 is pressed downwardly into the mounting groove 360. Since the middle frame 300 is a plastic member and has a certain deformation amount, during downward pressing of the first abutting edge 110, a part of the middle frame 300 provided with the clamping block 370 is deformed, so that the first abutting edge 110 can be pressed downwardly to a bottom of the mounting groove 360. Moreover, after the first abutting edge 110 is separated from the clamping block 370, the clamping block 370 is reset, so that the first abutting edge 110 is fastened to the clamping block 370 to realize assembly between the first can body 100 and the middle frame 300, and the first can body 100 is not easy to be separated from the middle frame 300, thus realizing stable connection. The user only needs to press the first can body 100 downwardly to realize the assembly, thus being convenient to operate.

With reference to FIG. 3 and FIG. 4, it can be understood that the clamping block 370 is provided with a guide portion 371, the guide portion 371 may be an inclined surface or an arc surface, and the guide portion 371 faces an opening of the mounting groove 360 for guiding the first abutting edge 110 at the lower end of the first can body 100 to enter the mounting groove 360, thus further improving convenience of assembling the first can body 100 and the middle frame 300.

In an embodiment, the fastening structure between the second can body 200 and the middle frame 300 may also include the mounting groove 360 and the clamping block 370 arranged in the middle frame 300. In this case, an assembly mode between the second can body 200 and the middle frame 300 may refer to an assembly mode between the first can body 100 and the middle frame 300 when the fastening structure between the first can body 100 and the middle frame 300 is also this structure, which will not repeated herein.

In an embodiment, the fastening structure between the first can body 100 and the middle frame 300 may also include the fastening hole 340 arranged in the middle frame 300 and the fastening nail connected to the first can body 100. In this case, an assembly mode between the first can body 100 and the middle frame 300 may refer to an assembly mode between the second can body 200 and the middle frame 300 when the fastening structure between the second can body 200 and the middle frame 300 is also this structure, which will not repeated herein.

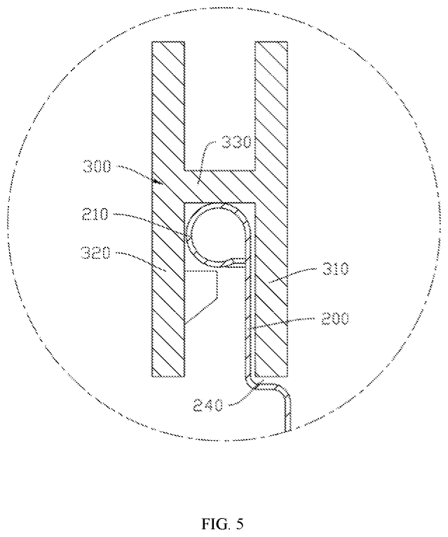

With reference to FIG. 5, it can be understood that when the fastening structure between the second can body 200 and the middle frame 300 includes the mounting groove 360 and the clamping block 370 arranged in the middle frame 300, the upper end of the inner wall of the second can body 200 is provided with an externally expanded step position 240, the inner plate 310 of the middle frame 300 is accommodated in the step position 240, and the inner wall of the inner plate 310 is flush with the inner wall of the second can body 200, so that the inner plate 310 can be avoided from protruding from the inner wall of the second can body 200, and a defect that the plastic bag is damaged or cannot be taken out due to that the inner plate 310 clamps the plastic bag so that is avoided, thus being convenient for the user to take out the plastic bag in the garbage can.

It can be understood that a connection structure between the second can body 200 and the bottom base 400 may refer to a connection structure between the first can body 100 and the middle frame 300, and a connection structure between the first can body 100 and the cover base 500 may refer to a connection structure between the second can body 200 and the middle frame 300, which will not be repeated herein.

The embodiments of the disclosure are described in detail with reference to the drawings above, but the disclosure is not limited to the above embodiments, and various changes may also be made within the knowledge scope of those of ordinary skills in the art without departing from the purpose of the disclosure.

1. A vertically-assembled garbage can, comprising:
a middle frame; and
two can bodies respectively mounted on both sides of the middle frame along a vertical direction, wherein an outer diameter of one of the can bodies is smaller than or equal to an inner diameter of the other one of the can bodies, the two can bodies are both provided with an abutting edge, at least one of the can bodies is detachably connected with the middle frame through a fastening structure, and the abutting edge is matched with the fastening structure to fix the can body.

2. The vertically-assembled garbage can according to claim 1, wherein the fastening structure comprises a fastening hole arranged in the middle frame and a fastening nail connected to the can body, the abutting edge is arranged to abut against the middle frame, the fastening nail is arranged penetrating through the fastening hole and is fastened to the middle frame, and a direction of a force of the abutting edge acting on the middle frame is opposite to a direction of a force of the fastening nail acting on the middle frame.

3. The vertically-assembled garbage can according to claim 2, wherein an inner wall of the can body is provided with a concave position, and an end portion of the fastening nail is accommodated in the concave position.

4. The vertically-assembled garbage can according to claim 2, wherein the can body mounted on a lower side of the middle frame is a second can body; in case that the second can body is detachably connected with the middle frame through the fastening structure, the middle frame is provided with a protruding portion protruding towards an interior of the garbage can, and the abutting edge of the second can body is arranged to abut against a lower side of the protruding portion.

5. The vertically-assembled garbage can according to claim 4, wherein an end surface of the protruding portion facing the interior of the garbage can is flush with an inner wall of the second can body.

6. The vertically-assembled garbage can according to claim 1, wherein the fastening structure comprises a mounting groove and a clamping block which are arranged in the middle frame, the clamping block is arranged on a side wall of the mounting groove, and the abutting edge is accommodated in the mounting groove and fastened to the clamping block.

7. The vertically-assembled garbage can according to claim 6, wherein the clamping block is provided with a guide portion facing an opening of the mounting groove.

8. The vertically-assembled garbage can according to claim 6, wherein the can body mounted on a lower side of the middle frame is a second can body; in case that the second can body is detachably connected with the middle frame through the fastening structure, the second can body is provided with an externally expanded step position, a part of the middle frame is accommodated in the step position, and an inner wall of the middle frame is flush with an inner wall of the second can body.

9. The vertically-assembled garbage can according to claim 1, wherein the two can bodies are respectively provided as a first can body mounted on an upper side of the middle frame and a second can body mounted on a lower side of the middle frame, and an outer diameter of the second can body is smaller than or equal to an inner diameter of the first can body.

10. The vertically-assembled garbage can according to claim 1, wherein the abutting edge is provided as a curled structure.
